(19) United States
(12) Patent Application Publication
(10) Pub. No.: US 2020/0097889 A1
(43) Pub. Date: Mar. 26, 2020

(54) DELIVERY SYSTEM AND NON-TRANSITORY COMPUTER READABLE MEDIUM

(71) Applicant: FUJI XEROX CO., LTD., Tokyo (JP)

(72) Inventors: Mariko MIYAZAKI, Kanagawa (JP); Hideki FUJIMOTO, Kanagawa (JP); Tetsuya KOBAYASHI, Kanagawa (JP); Hajime KAJIYAMA, Kanagawa (JP); Xiongfan JIN, Kanagawa (JP); Akira ICHIKAWA, Kanagawa (JP); Kunitoshi YAMAMOTO, Kanagawa (JP)

(73) Assignee: FUJI XEROX CO., LTD., Tokyo (JP)

(21) Appl. No.: 16/574,015

(22) Filed: Sep. 17, 2019

(30) Foreign Application Priority Data
Sep. 25, 2018 (JP) 2018-179043

(51) Int. Cl. G06Q 10/08; G06F 21/62

(52) U.S. Cl. CPC G06Q 10/083; G06F 21/6218

(57) ABSTRACT

A delivery system includes: a receiving unit that receives permission from a receiver who receives packages, the permission allowing delivery companies to inquire for information on the receiver; an obtaining unit that, when the permission is granted, from each of the delivery companies, obtains information on a corresponding one of the packages addressed to the receiver; and a generation unit that, when the information obtained by the obtaining unit satisfies a predetermined condition, generates information which allows the packages addressed to the receiver to be collectively delivered.

### CROSS-REFERENCE TO RELATED APPLICATIONS

This application is based on and claims priority under 35 USC 119 from Japanese Patent Application No. 2018-179043 filed Sep. 25, 2018.

### BACKGROUND

### (i) Technical Field

The present disclosure relates to a delivery system and a non-transitory computer readable medium.

### (ii) Related Art

For instance, Japanese Patent No. 6196325 discloses a collective delivery system in which a delivery destination pre-set by a user on the receive side who receives a package is obtained; when multiple packages collected from one or multiple shipping sources by multiple different delivery companies is delivered to a delivery destination by instructions of a user different from the user on the receive side, first delivery information associated with each package may be set so that delivery is made from its shipping source to a predetermined location different from the delivery destination, second delivery information associated with each package may be set so that collective delivery is made from a predetermined location to one delivery destination by a delivery company, it is determined whether the delivery destination in the first delivery information of each package of which the different user issued instructions for delivery matches one delivery destination pre-set by the user on the receive side, and when determination of matching is made, the delivery destination in the first delivery information is changed from the one delivery destination to the predetermined location.

### SUMMARY

In a general delivery system, each of multiple delivery companies individually delivers a package, thus, the package may be separately delivered even for the same delivery destination.

Aspects of non-limiting embodiments of the present disclosure relate to a delivery system that efficiently delivers multiple packages to the same delivery destination, as compared with the case where the packages are individually delivered to the delivery destination by multiple delivery companies.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided a delivery system including: a receiving unit that receives permission from a receiver who receives a plurality of packages, the permission allowing a plurality of delivery companies to inquire for information on the receiver; an obtaining unit that, when the permission is granted, from each of the plurality of delivery companies, obtains information on a corresponding one of the plurality of packages addressed to the receiver; and a generation unit that, when the information obtained by the obtaining unit satisfies a predetermined condition, generates information which allows the plurality of packages addressed to the receiver to be collectively delivered.

### BRIEF DESCRIPTION OF THE DRAWINGS

Exemplary embodiment of the present disclosure will be described in detail based on the following figures, wherein:

FIG. 1 is a diagram illustrating an overall configuration example of a delivery system according to an exemplary embodiment;

FIG. 2 is a diagram illustrating a hardware configuration example of a common user management server according to the exemplary embodiment;

FIG. 3 is a block diagram illustrating a functional configuration example of the common user management server according to the exemplary embodiment;

FIG. 4 is a block diagram illustrating a functional configuration example of a delivery task management server according to the exemplary embodiment;

FIG. 5 is a block diagram illustrating a functional configuration example of a delivery schedule management server according to the exemplary embodiment;

FIGS. 6A and 6B are each a flowchart illustrating an example of processing steps for user registration;

FIG. 7 is a flowchart illustrating an example of processing steps for delivery task generation;

FIG. 8 is a flowchart illustrating an example of processing steps for delivery task generation;

FIG. 9A illustrates an example of information on user A registered in a user information table, FIG. 9B illustrates an example of information on the user A managed by a delivery company server, FIG. 9C illustrates an example of information on the user A managed by the delivery company server, and FIG. 9D illustrates an example of information on the user A registered in the delivery company server;

FIG. 10A illustrates an example of information on user B registered in the user information table, FIG. 10B illustrates an example of information on user C managed by the delivery company server, and FIG. 10C illustrates an example of information on the user C registered in the user information table;

FIGS. 11A to 11C each illustrate an example of information on a package delivery request made by a user to a delivery company;

FIG. 12 illustrates an example of a delivery task generated by a delivery task generator; and

FIG. 13 illustrates an example of a delivery schedule generated by a schedule generator.

### DETAILED DESCRIPTION

Hereinafter, an exemplary embodiment according to the present disclosure will be described in detail with reference to the accompanying drawings.

### <The Overall Delivery System Configuration>

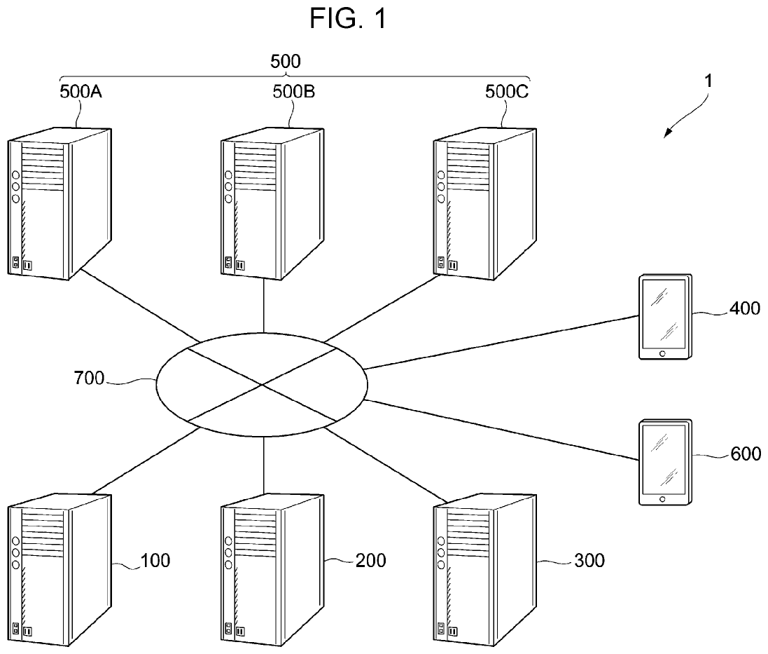

FIG. 1 is a diagram illustrating an overall configuration example of a delivery system 1 according to the exemplary embodiment. In the delivery system 1 according to the exemplary embodiment, a delivery person of the delivery system 1, provided separately from another delivery person of a delivery company, takes over delivery of a package collected by the delivery company, picks up the package managed by the delivery company, and delivers the picked up package to a delivery destination.

As illustrated, the delivery system 1 according to the exemplary embodiment includes a common user management server 100, a delivery task management server 200, a delivery schedule management server 300, a delivery person terminal 400, a delivery company server 500A, a delivery company server 500B, a delivery company server 500C, and a client terminal 600. These devices are connected to a network 700.

It is to be noted that the delivery company server 500A, the delivery company server 500B, and the delivery company server 500C are server devices managed by separate delivery companies, and when these server devices do not need to be distinguished, the server devices are simply referred to as a delivery company server 500. Although the example illustrated in FIG. 1 depicts three delivery company servers 500, the number of delivery company servers 500 is not limited to three as illustrated.

The common user management server 100 is a server device that manages information on users who utilize the delivery system 1. The common user management server 100 assigns a unique ID (in other words, identification information for identifying a user) to each of the users who utilize the delivery system 1, and manages information such as the name, address, and telephone number of the user. In addition, the common user management server 100 accesses the delivery company server 500 of each delivery company, and obtains information on a user managed at the delivery company server 500. In this case, the common user management server 100 may obtain information on users who have permitted disclosure of the information to the delivery system 1.

Hereinafter, the ID of a user assigned by the common user management server 100 may be referred to as the “common ID”.

The delivery task management server 200 is a server device that accesses the delivery company server 500 of each delivery company, and obtains a package delivery request made by a user to the delivery company. The delivery task management server 200 obtains information on a user from the common user management server 100, the user being managed by the common user management server 100. The delivery task management server 200 generates a delivery task based on the obtained information. The delivery task is such that delivery of a package is regarded as a task, and is generated for each delivery of a package. When multiple deliveries may be combined, the delivery task management server 200 combines multiple deliveries to a delivery task based on information on the location and user at a delivery destination of a package.

The delivery schedule management server 300 is a server device that generates a delivery schedule for delivering a package by a delivery person for each delivery task. The delivery schedule management server 300 generates a delivery schedule based on the address of a delivery center, the address of a delivery destination of a package, the current location of a delivery person, and other information. The delivery center is a final station of packages for delivery companies, and is the location where packages to be delivered to respective delivery destinations are kept. A delivery person of the delivery system 1 picks up a package at a delivery center in accordance with a delivery schedule, and delivers the picked up package to a delivery destination.

The delivery person terminal 400 is a terminal device used by the delivery person of the delivery system 1, and includes, for instance, a mobile information terminal, such as a smartphone, and a mobile phone, as an example. The delivery person terminal 400 obtains information on the current location of the terminal itself, for instance, by a global positioning system (GPS), and transmits the obtained information on the current location to the delivery schedule management server 300 regularly (for instance, every minute). In addition, the delivery person terminal 400 receives information on delivery schedule from the delivery schedule management server 300. The delivery person delivers a package in accordance with the received delivery schedule.

The delivery company server 500 is a server device managed by an individual delivery company. The individual delivery company manages each user as a receiver who receives a package in its own way. In the delivery company server 500, for each user, information, such as the name, address, and telephone number of the user, a unique ID granted to the user, is registered. When receiving a package delivery request from a user, the individual delivery company stores information on the received delivery request in the delivery company server 500.

It is to be noted that although the delivery company manages at least one delivery company server 500, the delivery company may manage multiple delivery company servers 500.

Hereinafter, the ID of a user assigned by a delivery company server 500 may be referred to as the “individual ID”.

The client terminal 600 is a terminal apparatus used by a user who requests for delivery of a package, and includes, for instance, a mobile information terminal, such as a smartphone, and a mobile phone, as an example. For instance, a user views a website on the Internet using the client terminal 600, and purchases a product on a website. At this point, a user requests for delivery of a product purchased, and the client terminal 600 receives the delivery request of the product. Information on the received delivery request is transmitted to, for instance, the shop that sells the product, and delivery of the package is requested from the shop to the delivery company server 500. Alternatively, a user may access the delivery company server 500 to request for delivery of a package.

The client terminal 600 displays a user registration screen, and receives information on a user to be registered in the delivery system 1. A user (hereinafter referred to as a registration user) registered in the delivery system 1 may utilize delivery service provided by delivery persons of the delivery system 1. Information on each registration user is transmitted from the client terminal 600 to the common user management server 100, and is managed by the common user management server 100 as described above.

The network 700 is a communication unit used for information communication in the common user management server 100, the delivery task management server 200, the delivery schedule management server 300, the delivery person terminal 400, the delivery company server 500, and the client terminal 600. The network 700 includes, for instance, the Internet, a public line, and a local area network (LAN). In addition, the network 700 includes a network by wired communication, and a network by wireless communication.

### <Hardware Configuration of Common User Management Server>

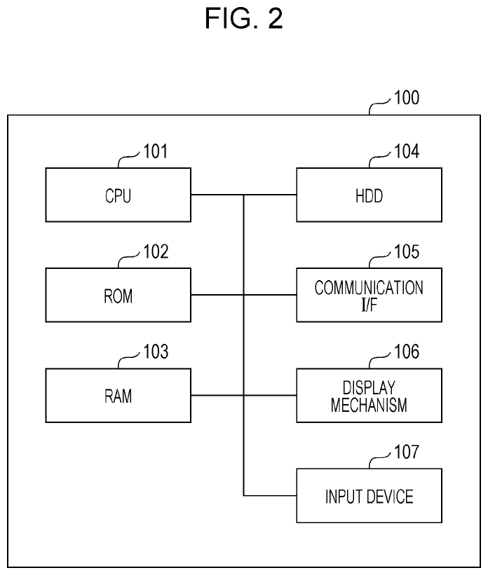

FIG. 2 is a diagram illustrating a hardware configuration example of the common user management server 100 according to the exemplary embodiment.

As illustrated, the common user management server 100 according to the exemplary embodiment includes a central processing unit (CPU) 101 which is a calculation unit, a read only memory (ROM) 102 which is a storage area for programs such as a basic input output system (BIOS), and a random access memory (RAM) 103 which is an execution area for programs. In addition, the common user management server 100 includes a hard disk drive (HDD) 104 which is a storage area that stores various programs such as an operating system (OS) and application, input data to the various programs, and output data from the various programs.

Furthermore, the common user management server 100 includes a communication interface (communication I/F) 105 for performing communication with the outside, a display mechanism 106 such as a display, and an input devices 107 such as a keyboard, a mouse, and a touch panel.

As an example, a configuration similar to the hardware configuration illustrated in FIG. 2 may be used for the delivery task management server 200, the delivery schedule management server 300, the delivery person terminal 400, the delivery company server 500, the client terminal 600.

### <Functional Configuration of Common User Management Server>

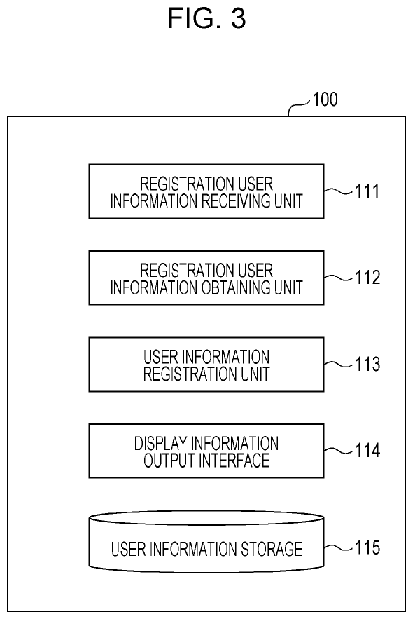

Next, the functional configuration of the common user management server 100 according to the exemplary embodiment will be described. FIG. 3 is a block diagram illustrating a functional configuration example of the common user management server 100 according to the exemplary embodiment. The common user management server 100 according to the exemplary embodiment includes a registration user information receiving unit 111, a registration user information obtaining unit 112, a user information registration unit 113, a display information output interface 114, and a user information storage 115.

The registration user information receiving unit 111 as an example of a receiving unit receives user information on a user who registers in the delivery system 1. For instance, when user information, such as the name, address, and telephone number of a user, is inputted to a user registration screen displayed on a display of the client terminal 600, the registration user information receiving unit 111 receives the inputted user information.

As more specifically described below, on the user registration screen, one of more delivery companies to be utilized by each user are selected. Each user is deemed to have permitted the selected one or more delivery companies to disclose information on the user, managed by the delivery companies to the delivery system 1. In other words, each user is deemed to have permitted the selected one or more delivery companies to inquire for the information on the user. As an additional remark, for selection of a delivery company, for instance, a user may select one or more delivery companies from predetermined multiple delivery companies, or may collectively select predetermined multiple delivery companies.

When a user utilized a delivery company in the past, the user may input its individual ID granted by the delivery company on the user registration screen.

When the user completes the input of user information on the user registration screen, and performs registration, the information inputted on the user registration screen (in other words, the information received by the registration user information receiving unit 111) is registered in the user information table by the user information registration unit 113 as described later.

When a user is registered, the registration user information obtaining unit 112 accesses the delivery company server 500 of a delivery company selected to be utilized by the registration user, and obtains information on the individual ID of the registration user managed by the delivery company server 500. For instance, when the individual ID is inputted on the user registration screen, the registration user information obtaining unit 112 refers to the registration user based on the inputted individual ID, and determines whether or not the individual ID is valid. For instance, when an individual ID is not inputted on the user registration screen, the registration user information obtaining unit 112 refers to the registration user based on the information such as the name, address, and telephone number of the registration user, and obtains the individual ID of the registration user as the valid ID, the registration user being managed by the delivery company server 500.

In this manner, the registration user information obtaining unit 112 obtains information on the individual ID of the registration user from each delivery company server 500 selected to be utilized by the registration user. For each user, various types of information are considered to be registered in the delivery company server 500 of each delivery company, thus the registration user information obtaining unit 112 may obtain not only the individual ID but also other information on the registration user.

In the user information table, the registration user information obtaining unit 112 obtains information on one or more other users having the same address as that of the registration user. The one or more other users refer to a family member of the registration user, and a live-in person other than the family, and is handled as a user (hereinafter, referred to as a live-in user) who lives together with the registration user.

Furthermore, the registration user information obtaining unit 112 accesses the delivery company server 500 of a delivery company selected to be utilized by the registration user, and obtains information on one or more other users having the same registered address as that of the registration user, the one or more other users being among the users who have permitted disclosure of the information on the users to the delivery system 1. Such a user is also handled a live-in user who lives together with the registration user.

However, when obtaining information on a live-in user, the registration user information obtaining unit 112 does not need to access the delivery company server 500 of a delivery company selected to be utilized by the registration user. For instance, the registration user information obtaining unit 112 may access all the delivery company servers 500 in the delivery system 1 to obtain information on each live-in user who lives together with the registration user.

When a user is registered, the user information registration unit 113 assigns a common ID to the registration user. The user information registration unit 113 then registers information on the registration user received by the user information receiving unit and the common ID in the user information table in association with each other. In addition, the user information registration unit 113 registers information on registration user, such as the individual ID, in the user information table in association with the common ID of the registration user, the information being obtained from the delivery company server 500 by the registration user information obtaining unit 112. Furthermore, the user information registration unit 113 also registers the information on each live-in user who lives together with the registration user in the user information table in association with the common ID of the registration user.

The display information output interface 114 outputs data for displaying a screen on the display of the client terminal 600. For instance, the display information output interface 114 outputs information on the user registration screen to the client terminal 600, and displays the user registration screen on the display of the client terminal 600.

The user information storage 115 stores the user information table. A user is able to refer to, change, and delete user information on the registration user itself by accessing the user information table from the client terminal 600.

Each functional component included in the common user management server 100 is implemented by cooperatively using software and hardware resources. Specifically, for instance, when the common user management server 100 in the hardware configuration illustrated in FIG. 2 is implemented, various programs stored in HDD 104 are read in RAM 103, and executed by CPU 101, and thus the functional units such as the registration user information receiving unit 111, the registration user information obtaining unit 112, the user information registration unit 113, and the display information output interface 114 illustrated in FIG. 3 are implemented. The user information storage 115 is implemented by the HDD 104, for instance.

### <Functional Configuration of Delivery Task Management Server>

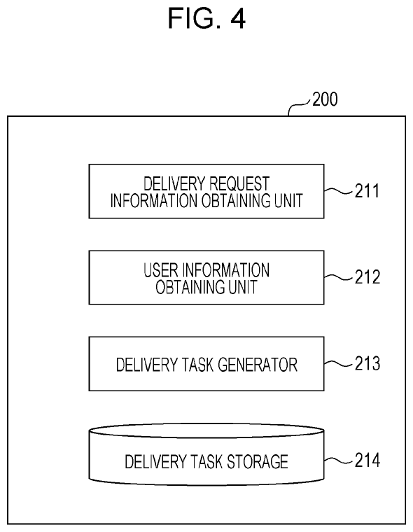

Next, the functional configuration of the delivery task management server 200 according to the exemplary embodiment will be described. FIG. 4 is a block diagram illustrating a functional configuration example of the delivery task management server 200 according to the exemplary embodiment. The delivery task management server 200 according to the exemplary embodiment includes a delivery request information obtaining unit 211, a user information obtaining unit 212, a delivery task generator 213, and a delivery task storage 214.

The delivery request information obtaining unit 211 as an example of an obtaining unit accesses the delivery company server 500 of each delivery company regularly (for instance, every hour), and obtains information on a package delivery request received from a user by the delivery company. From the delivery company server 500 of each delivery company, the delivery request information obtaining unit 211 obtains information on a delivery request for a package addressed to a user who has permitted disclosure of the information on the user to the delivery system 1. For instance, when a user permits disclosure of the information on the user to a delivery company server 500A and a delivery company server 500B, information on a delivery request for a package addressed to the user is obtained from each of the delivery company server 500A and the delivery company server 500B.

The user information obtaining unit 212 obtains information on a user at a delivery destination from the common user management server 100, the delivery destination being in a delivery request obtained by the delivery request information obtaining unit 211.

The delivery task generator 213 as an example of a generation unit generates a delivery task for each delivery of a package based on information on the delivery request obtained by the delivery request information obtaining unit 211 and the information on a user obtained by the user information obtaining unit 212. The delivery task generator 213 may generate a delivery task, for instance, at the timing of obtaining the information on the delivery request by the delivery request information obtaining unit 211, or generate a delivery task on stand-by for obtaining information on another delivery request after the information on the delivery request is obtained by the delivery request information obtaining unit 211. Alternatively, the delivery task generator 213 may generate a delivery task, for instance, after a predetermined number of delivery requests are accumulated.

As more specifically described below, the delivery task generated by the delivery task generator 213 includes information such as, the name, address, telephone number, and common ID of a user at a delivery destination, and a task status indicating the status of the delivery task. When a desired date of delivery is designated by a user who has made a delivery request, the designated desired date of delivery is also included in the delivery task. When information on multiple packages included in the delivery request satisfies a predetermined condition, the delivery task generator 213 generates a delivery task by combining deliveries of the multiple packages. In the exemplary embodiment, a delivery task generated by combining deliveries of multiple packages is used as an example of information that allows multiple packages to be collectively delivered.

More specifically, a method of combining deliveries includes a technique of combining deliveries using the location of a delivery destination of each package as the key, and a technique of combining deliveries using the user at a delivery destination of a package as the key. When the address of a delivery destination of a package is designated, the technique of combining deliveries using the location as the key is used, whereas when the address of a delivery destination of a package is not designated, the technique of combining deliveries using the user as the key is used.

For instance, when packages are addressed to the same user and the addresses of delivery destinations are the same, the delivery task generator 213 combines the two deliveries into one delivery task by the technique of combining deliveries using the location as the key. For instance, even for packages addressed to different users, when the users are members of a family or have a live-in relationship, and the same address is used for a delivery destination, the delivery task generator 213 combines delivery tasks for the users to one delivery task. However, even when the users are members of a family or have a live-in relationship, if delivery to a live-in user is not permitted, separate delivery tasks are generated without combining the delivery tasks to one delivery task.

Meanwhile, for instance, for some of packages, even when the user at a delivery destination is designated, the address of the delivery destination may not be fixed. In this situation, the delivery task generator 213 combines the packages addressed to the same user to one delivery task by the technique of combining deliveries using the user as the key. The delivery task management server 200 or the delivery schedule management server 300 notifies the user at a delivery destination of the location of the delivery destination via e-mail, and receives designation of the location of the delivery destination from the user.

The delivery task storage 214 stores information on a delivery task generated by the delivery task generator 213.

Similarly to the common user management server 100, for instance, various programs stored in a HDD are read in a RAM, and executed by a CPU, and thus the functional units such as the delivery request information obtaining unit 211, the user information obtaining unit 212, and the delivery task generator 213 illustrated in FIG. 4 are implemented. The delivery task storage 214 is implemented by a HDD, for instance.

### <Functional Configuration of Delivery Schedule Management Server>

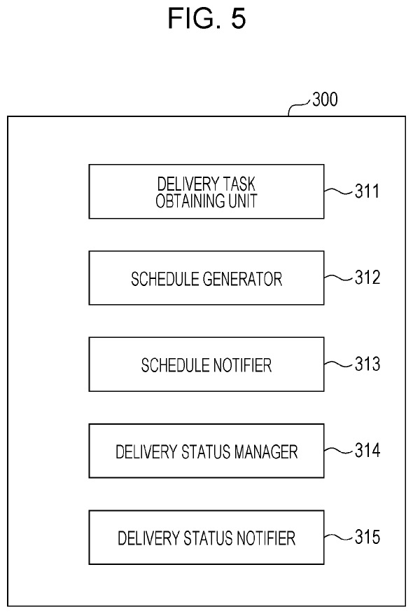

Next, the functional configuration of the delivery schedule management server 300 according to the exemplary embodiment will be described. FIG. 5 is a block diagram illustrating a functional configuration example of the delivery schedule management server 300 according to the exemplary embodiment. The delivery schedule management server 300 according to the exemplary embodiment includes a delivery task obtaining unit 311, a schedule generator 312, a schedule notifier 313, a delivery status manager 314, and a delivery status notifier 315.

The delivery task obtaining unit 311 obtains information on a delivery task generated by the delivery task management server.

For each delivery task obtained by the delivery task obtaining unit 311, the schedule generator 312 generates a delivery schedule for delivering a package by a delivery person for the delivery system 1. For each delivery task, the schedule generator 312 generates a delivery schedule based on the address of a delivery center at which a package arrives, a scheduled time when the package arrives at the delivery center, the address of a delivery destination of the package, and the current location of the delivery person. For instance, when multiple packages arrive at the same delivery center for a delivery task in which deliveries of the multiple packages are combined, the schedule generator 312 generates a delivery schedule so that a delivery person arrives at the delivery center at the latest scheduled arrival time.

The schedule notifier 313 notifies the delivery person terminal 400 of the delivery schedule generated by the schedule generator 312. When multiple delivery persons are involved, the delivery person terminal 400 of each of the delivery persons is notified of a delivery schedule.

The delivery status manager 314 manages the delivery status of a package for each delivery task. The delivery status manager 314 updates information on a delivery schedule according to the delivery status of a package. For instance, when a delivery person receives a package at a delivery center, the delivery person operates the delivery person terminal 400, thereby notifying the delivery schedule management server 300 that the delivery person has received a package. In response to the notification, the delivery status manager 314 changes the task status of the delivery task stored in the delivery task storage 214 from “on route to collection” to “on route to delivery”.

The delivery status notifier 315 as an example of an instruction unit and a notification unit notifies a user at a package delivery destination of information on the delivery status of the package and the current location of the package, and the scheduled arrival time of the package. In addition, when the delivery person for the delivery system 1 delivers a package, the delivery status notifier 315 instructs the delivery company server 500 of a delivery company which manages the package not to deliver the package. Furthermore, when delivery of the package is completed, the delivery status notifier 315 notifies the delivery company server 500 of a delivery company which manages the package that delivery of the package has been completed. It is to be noted that instruction or notification to a delivery company is not necessarily sent to the delivery company server 500.

It is sufficient that instruction or notification be sent to a delivery company, and for instance, instruction or notification may be sent to an administrator of the delivery company server 500 or a person in charge who takes charge of delivery of the package at a delivery company via e-mail.

Similarly to the common user management server 100, for instance, various programs stored in a HDD are read in a RAM, and executed by a CPU, and thus the functional units such as the delivery task obtaining unit 311, the schedule generator 312, the schedule notifier 313, the delivery status manager 314, and the delivery status notifier 315 illustrated in FIG. 5 are implemented.

### <Processing Steps for User Registration>

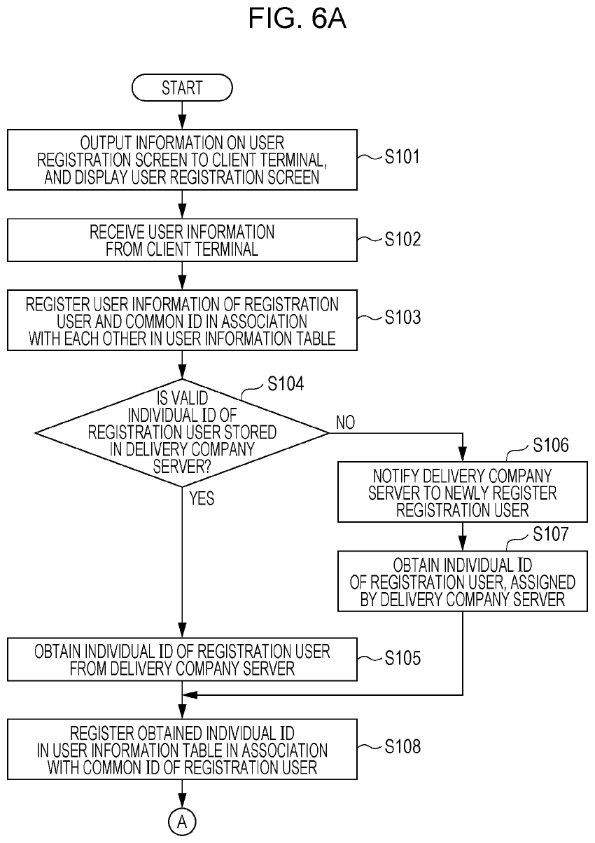

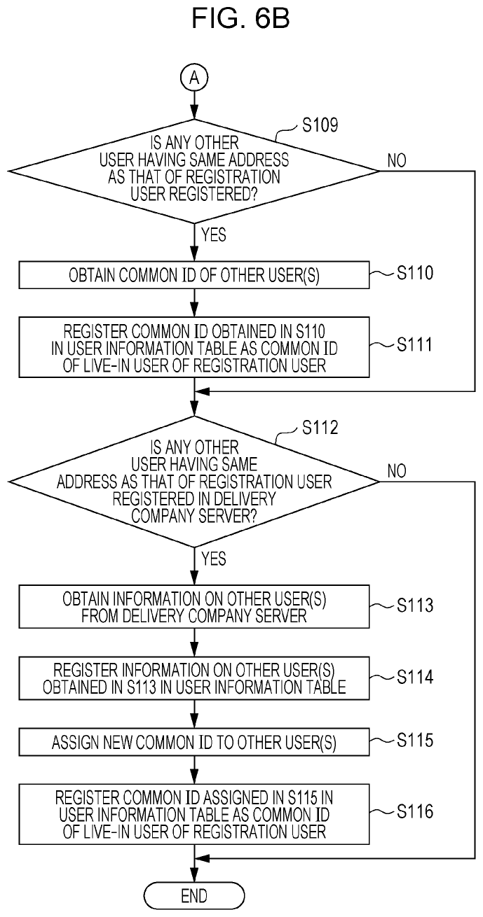

Next, the steps of processing of user registration performed by the common user management server 100 will be described. FIGS. 6A and 6B are each a flowchart illustrating an example of processing steps for user registration.

Hereinafter, a step in processing may be denoted by a symbol “S”.

First, when a user accesses the common user management server 100 from the client terminal 600 to register in the delivery system 1, the display information output interface 114 outputs information on a user registration screen to the client terminal 600. The display information output interface 114 then displays the user registration screen on the display of the client terminal 600 (S101). Subsequently, the registration user information receiving unit 111 receives user information from the client terminal 600 (S102).

Subsequently, when user registration is performed based on the received user information, the user information registration unit 113 assigns a common ID to the registration user. The user information on the registration user and the common ID are registered in the user information table in association with each other (S103). Subsequently, the registration user information obtaining unit 112 accesses the delivery company server 500 of a delivery company selected to be utilized by the registration user, and determines whether or not a valid individual ID of the registration user is stored in the delivery company server 500 (S104).

When positive determination (YES) is made in S104, the registration user information obtaining unit 112 obtains the individual ID of the registration user from the delivery company server 500 (S105). On the other hand, when negative determination (NO) is made in S104, the registration user information obtaining unit 112 transmits the user information on the registration user to the delivery company server 500, and notifies the delivery company server 500 to newly register the registration user (S106). The registration user information obtaining unit 112 then obtains an individual ID of the registration user, granted by the delivery company server 500 (S107).

It is to be noted that the processing in S104 to S107 is performed by the delivery company server 500 of each delivery company selected to be utilized by the registration user.

After S105 or S107, the user information registration unit 113 registers the individual ID obtained in S105 and the individual ID obtained in S107 in the user information table in association with the common ID of the registration user (S108). Subsequently, the registration user information obtaining unit 112 determines whether or not one or more other users having the same address as that of the registration user are registered in the user information table (S109). When positive determination (YES) is made in S109, the registration user information obtaining unit 112 obtains the common ID of each of the one or more other users (S110). Subsequently, the user information registration unit 113 registers the common ID obtained in S110 in the user information table as the common ID of a live-in user of the registration user (S111).

After S111 or when negative determination (NO) is made in S109, the registration user information obtaining unit 112 accesses the delivery company server 500 of each delivery company selected to be utilized by the registration user. The registration user information obtaining unit 112 determines whether or not one or more other users having the same address as that of the registration user are registered in the delivery company server 500, the one or more other users being among the users who have permitted disclosure of the information on the users to the delivery system 1 (S112).

When negative determination (NO) is made in S112, the processing flow is completed.

On the other hand, when positive determination (YES) is made in S112, the registration user information obtaining unit 112 obtains information on the one or more other users from the delivery company server 500 (S113). The obtained information on the one or more other users is handled as the information on a live-in user of the registration user. Subsequently, in order to register the one or more other users in the delivery system 1, the user information registration unit 113 registers the information on the one or more other users obtained in S113 in the user information table (S114). At this point, the user information registration unit 113 newly assigns a common ID to each of the one or more other users (S115). The user information registration unit 113 registers the common ID assigned in S115 in the user information table as the common ID of a live-in user of the registration user (S116). The processing flow is then completed.

It is to be noted that the processing in S112 to S116 is performed by the delivery company server 500 of each delivery company selected to be utilized by the registration user.

### <Processing Steps for Delivery Task Generation>

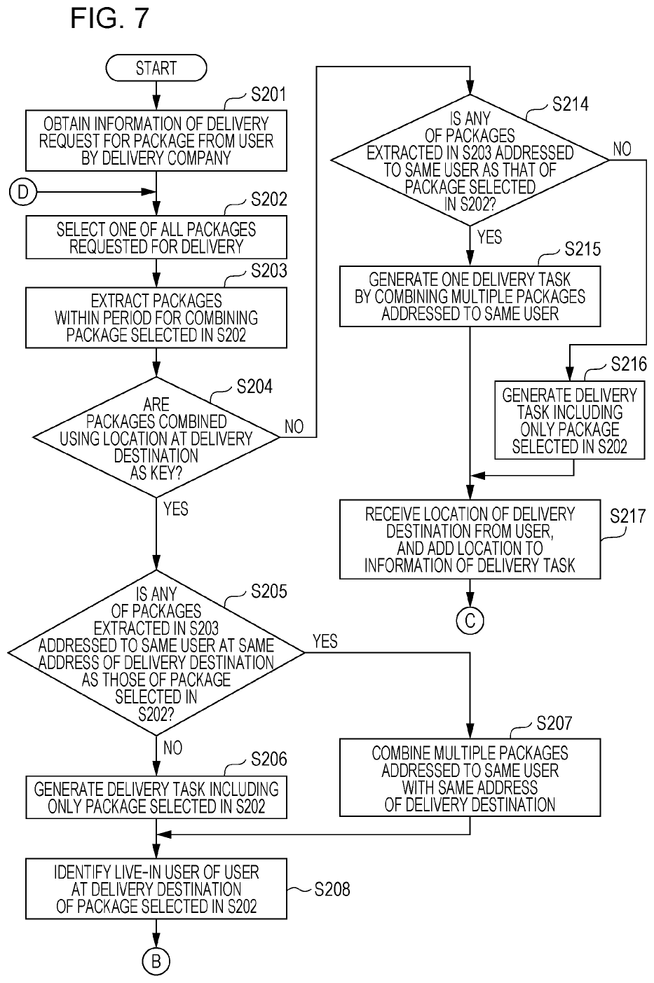

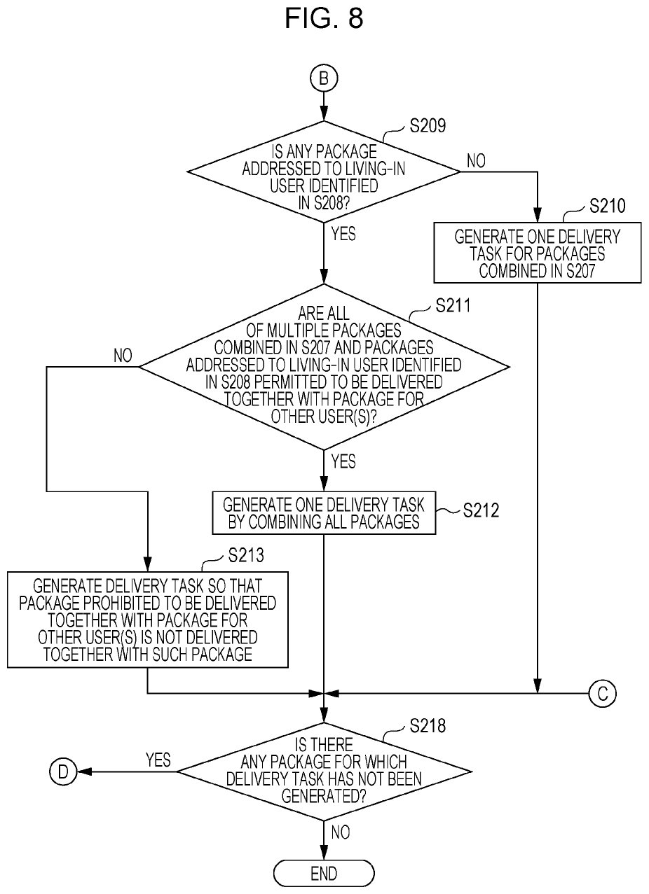

Subsequently, the steps of processing for delivery task generation performed by the delivery task management server 200 will be described. FIGS. 7 and 8 are each a flowchart illustrating an example of processing steps for delivery task generation.

First, the delivery request information obtaining unit 211 accesses the delivery company server 500 of each delivery company, and obtains information on a package delivery request made to the delivery company by a user (S201). The delivery request information obtaining unit 211 obtains information on a delivery request for a package addressed to a user who has permitted disclosure of the information on the user to the delivery system 1. Subsequently, the delivery task generation unit 213 refers to the obtained information on a delivery request, and selects one of all packages for which delivery is requested (S202).

Subsequently, among all packages for which delivery is requested, the delivery task generation unit 213 retrieves package(s) to be combined with the package selected in S202 within a predetermined period as the period for combining packages (S203). The period for combining packages is defined as the period used for determining whether or not deliveries of multiple packages are combined. For instance, the period for combining packages is an upper limit period during which the package selected in S202 is allowed to stay in the delivery center. In this case, a scheduled time of arrival of the package selected in S202 at the delivery center serves as a reference time, and a package is retrieved which is scheduled to arrive at the delivery center within a predetermined period from the reference time.

Subsequently, the delivery task generator 213 determines whether or not the package selected in S202 is combined with other package(s) using the location of a delivery destination of each package as the key (S204). In the determination of S204, for instance, when delivery to the address of the user at a delivery destination is clearly designated or when the address of the user at a delivery destination is registered in the user information table and no instructions for delivery to another location are provided, positive determination (YES) is made. On the other hand, for instance, when the address of the user at a delivery destination is not fixed or when the address of the user at a delivery destination is registered in the user information but instructions prohibiting delivery to the address are provided, negative determination (NO) is made. In this case, the technique of combining deliveries using the user at delivery destination of the package as the key is used.

When positive determination (YES) is made in S204, the delivery task generator 213 determines whether or not any of the package(s) retrieved in S203 is addressed to the same user at the same address of the delivery destination as the package selected in S202 (S205).

When negative determination (NO) is made in S205, the delivery task generator 213 generates a delivery task including only the package selected in S202 (S206).

On the other hand, when positive determination (YES) is made in S205, the delivery task generator 213 combines multiple packages addressed to the same user at the same address of the delivery destination (S207).

After S206 or S207, the delivery task generator 213 refers to the user information table, and identifies live-in user(s) of the user at the delivery destination of the package selected in S202 (S208). Subsequently, the delivery task generator 213 determines whether or not any of the package(s) retrieved in S203 is addressed to the live-in user(s) identified in S208 (S209). When negative determination (NO) is made in S209, the delivery task generator 213 generates one delivery task for the packages combined in S207 (S210).

On the other hand, when positive determination is made (YES) in S209, the delivery task generator 213 determines whether or not each of multiple packages combined in S207 and the package addressed to the live-in user(s) identified in S208 is permitted to be delivered together with a package addressed to another user (S211). When all the packages are permitted to be delivered together with a package addressed to another user (YES in S211), the delivery task generator 213 generates one delivery task by combining all the packages (S212). On the other hand, at least one package is not permitted to be delivered together with a package addressed to another user (NO in S211), the delivery task generator 213 generates a delivery task so that the package not permitted to be delivered together with a package addressed to another user is not delivered together with such a package (S213).

In S213, one delivery task is generated by combining only the packages permitted to be delivered together with a package addressed to another user, for instance. On the other hand, for each package not permitted to be delivered together with a package addressed to another user, a delivery task is generated for each user at a delivery destination. For instance, for all the packages, a delivery task may be generated for each user at a delivery destination.

When negative determination (NO) is made in S204, processing of combining deliveries using the user at a delivery destination of the package as the key is performed. In this case, the delivery task generator 213 determines whether or not any of the package(s) retrieved in S203 is addressed to the same user as the package selected in S202 (S214). When positive determination (YES) is made in S214, the delivery task generator 213 generates one delivery task by combining multiple packages addressed to the same user (S215). On the other hand, when negative determination is made in S214, the delivery task generator 213 generates a delivery task including only the package selected in S202 (S216). After S215 or S216, the delivery task generator 213 sends a notification to the user at a delivery destination via e-mail, receives the location of the delivery destination from the user, and adds the location to the information on the delivery task (S217).

After S210, S212, S213, or S217, the delivery task generator 213 determines whether or not a delivery task is not generated for at least one of all packages for which delivery is requested in the information on the delivery request obtained in S201 (S218). When a positive determination (YES) is performed in S218, the flow proceeds to S202. On the other hand, when negative determination (NO) is made in S218, the processing flow is completed.

### <Description of Processing of Common User Management Server>

Next, the processing of the common user management server 100 will be described by giving a specific example.

For instance, when user A accesses the common user management server 100 from the client terminal 600, a user registration screen is displayed on the display of the client terminal 600. When user A inputs user information, such as the name, address, and telephone number of the user A on the user registration screen, user registration is performed. On the user registration screen, one of more delivery companies to be utilized by the user A are selected. On the user registration screen, the user A may input its individual ID granted by a delivery company utilized by the user A in the past.

In this example, the user A selects three delivery companies: a delivery company A that manages the delivery company server 500A, a delivery company B that manages the delivery company server 500B, and a delivery company C that manages the delivery company server 500C. The user A utilizes the service of the delivery company A in the past, and inputs an individual ID “333” which was granted when the user A utilized the service.

When the user A is registered, the user information registration unit 113 assigns a common ID to the user A. The user information registration unit 113 then registers information on the user A inputted to the user registration screen, and the common ID in the user information table in association with each other.

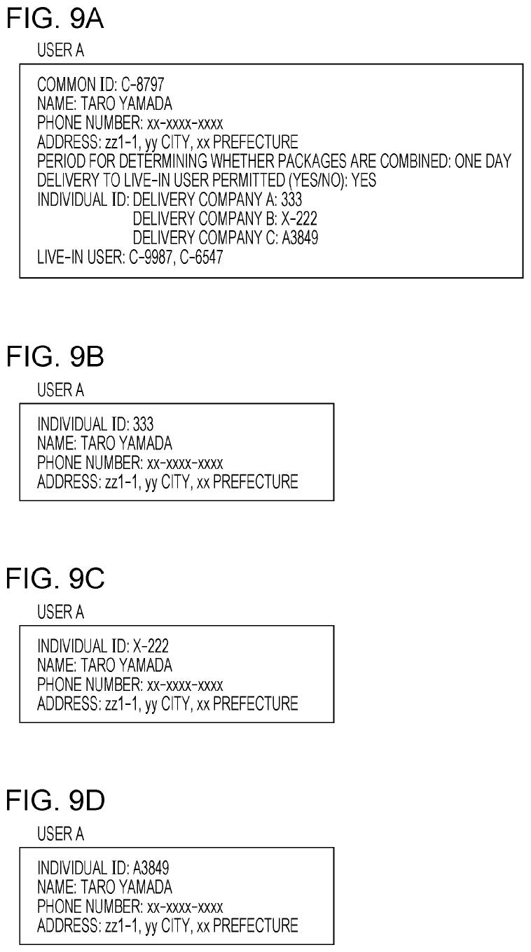

FIG. 9A illustrates an example of information on the user A registered in the user information table. In the illustrated example, the common ID is “C-8797”, the name of the user A is “Taro Yamada”, the telephone number is “xx-xxxx-xxxx”, and the address is “zz1-1, yy city, xx prefecture”.

“One day” is designated as the period for combining packages. For instance, the upper limit period during which the package of the user A is allowed to stay in the delivery center to combine packages is one day. In other words, for one package and the other package, when the difference between a scheduled time of arrival of the one package at the delivery center and a scheduled time of arrival of the other package at the delivery center is less than or equal to one day, the two packages are to be combined. However, the period for combining packages is not limited to the upper limit period during which the one package is allowed to stay in the delivery center. For instance, the period for combining packages may be a period relative to the time when delivery request for the one package is made. In this case, for instance, for one package and the other package, when the difference between the time when delivery request for the one package is made and the time when delivery request for the other package is made is less than or equal to one day, the two packages are to be combined.

Live-in user delivery permitted YES/NO is setting for whether or not a package addressed to the user A and a package addressed to a live-in user of the user A are permitted to be collectively delivered. In the case of “YES”, a package addressed to the user A and a package addressed to a live-in user are permitted to be collectively delivered. On the other hand, in the case of “NO”, a package addressed to the user A and a package addressed to a live-in user are not permitted to be collectively delivered, and the packages are assigned to separate delivery tasks.

For the setting of live-in user delivery permitted YES/NO, “YES” or “NO” may be set according to the type of a package or the property of a package. Although underage drinking of liquor and alcoholic beverages is prohibited, for instance, when a package for children and liquor or alcoholic beverages are collectively delivered, a child may receive a package of liquor or alcoholic beverages. Thus, “NO” is set for liquor and alcoholic beverages. For instance, when a package is expensive, it is preferable that the user at a destination of the package directly receive the package, thus “NO” is set.

Furthermore, a live-in user, for whom collective delivery is permitted, may be designated. For instance, the setting is made such that a package addressed to an adult live-in user and liquor or alcoholic beverages may be collectively delivered. For instance, the setting is made such that a package addressed to a reliable live-in user and a package containing an expensive product may be collectively delivered.

As described later, the setting of live-in user delivery permitted YES/NO may be made for each package to be delivered.

The setting of live-in user delivery permitted YES/NO may be regarded as the setting for whether even a package addressed to the same address as that of the user at a delivery destination is individually delivered. In this situation, in the case of “YES”, delivery addressed to an individual is permitted. For instance, a package addressed to the user A and a package addressed to a live-in user are assigned to separate delivery tasks. On the other hand, in the case of “NO”, delivery addressed to an individual is not permitted. For instance, a delivery task is generated by combining a package addressed to the user A and a package addressed to a live-in user.

Furthermore, the individual ID granted to the user A by the delivery company server 500, and information on a live-in user of the user A are registered in the user information table.

More specifically, when the user A is registered, the registration user information obtaining unit 112 accesses the delivery company servers 500A to 500C of the delivery companies selected to be utilized by the user A, and obtains the individual ID of the user A managed by the delivery company servers 500A to 500C.

For instance, the registration user information obtaining unit 112 accesses the delivery company server 500A to make an inquiry for the user A based on the individual ID “333” inputted for the user A, and determines whether or not the individual ID “333” is valid. FIG. 9B illustrates an example of information on the user A managed by the delivery company server A. The registration user information obtaining unit 112 compares, for instance, the name, address, and telephone number of the user A inputted to the user registration screen with the name, address, and telephone number of the user registered as the individual ID “333”. When all of the fields match, the registration user information obtaining unit 112 determines that the user A and the user with the individual ID “333” are the same, and the individual ID “333” is the valid individual ID of the user A.

For instance, the registration user information obtaining unit 112 accesses the delivery company server 500B to make an inquiry for the user A based on the information on the name, address, and telephone number of the user A, and obtains the individual ID of the user A managed by the delivery company server 500B. FIG. 9C illustrates an example of information on the user A managed by the delivery company server B. Here, the name, address, and telephone number of the user with the individual ID “X-222” match the name, address, and telephone number of the user A inputted to the user registration screen. Thus, the registration user information obtaining unit 112 obtains “X-222” as the valid individual ID of the user A.

Furthermore, for instance, the registration user information obtaining unit 112 accesses the delivery company server 500C to make an inquiry for the user A based on the information on the name, address, and telephone number of the user A, and obtains the individual ID of the user A managed by the delivery company server 500C. In this example, the user A has not been registered yet in the delivery company server 500C. Thus, the registration user information obtaining unit 112 notifies the delivery company server 500C to newly register the user A. At this point, the registration user information obtaining unit 112 also notifies the delivery company server 500C of the information on the user A inputted on the user registration screen. FIG. 9D illustrates an example of information on the user A registered in the delivery company server C. As illustrated in FIG. 9D, the name, address, and telephone number of the user A inputted on the user registration screen are registered in the delivery company server 500C. In the delivery company server 500C, “A3849” is newly granted as the individual ID of the user A. The registration user information obtaining unit 112 obtains “A3849” as the valid individual ID of the user A.

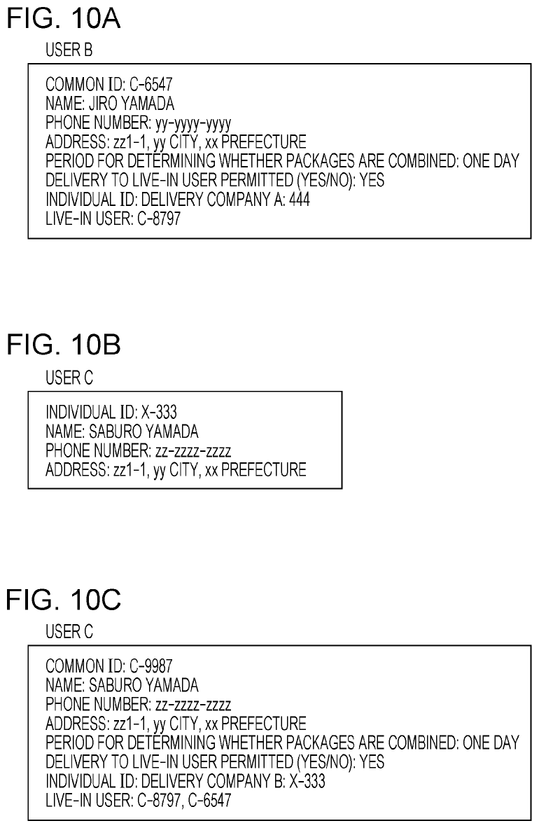

In the user information table, the registration user information obtaining unit 112 obtains information on one or more other users having the same address as that of the user A. In this example, user B has the same registered address as that of the user A. FIG. 10A illustrates an example of information on the user B registered in the user information table. In the illustrated example, the address of the user B with a common ID “C-6547” is the same as the address of the user A. Thus, the common ID “C-6547” of the user B is registered as the common ID of a live-in user of the user A. Also, the common ID “C-8797” of the user A is registered as the common ID of a live-in user of the user B.

Furthermore, the registration user information obtaining unit 112 accesses the delivery company servers 500A to 500C of the delivery companies selected to be utilized by the user A, and obtains information on one or more other users having the same registered address as that of the user A, the one or more other users being among the users who have permitted disclosure of the information on the users to the delivery system 1. In this example, user C in the delivery company server 500B has the same registered address as that of the user A. FIG. 10B illustrates an example of information on the user C managed by the delivery company server 500B. In the illustrated example, the address of the user C with an individual ID “X-333” is the same as the address of the user A. Thus, the user C is handled a live-in user of the user A.

Here, user C is also registered in the delivery system 1. FIG. 10C illustrates an example of information on the user C registered in the user information table. As illustrated, the information on the user C managed by the delivery company server 500B is registered in the user information table. At this point, a common ID “C-9987” is newly granted to the user C. The common ID “C-9987” of the user C is registered as the common ID of a live-in user of the user A. Furthermore, the common ID “C-9987” is also registered as the common ID of a live-in user of the user B. In contrast, the common ID “C-8797” of the user A is registered as the common ID of a live-in user of the user C. The common ID “C-6547” of the user B is also registered as the common ID of a live-in user of the user C.

It is to be noted that information on a live-in user of the user A may be manually registered. For instance, when the user A inputs information on a live-in user together with the information on the user A on the user registration screen, a common ID is granted to the live-in user, and information on the live-in user is registered in the user information table. For instance, at the time of user registration, the user A may input the common ID of a live-in user registered already. In this case, when the address of a user identified based on the common ID is the same as the address of the user A, the common ID is determined to be a valid individual ID, and is registered as the common ID of a live-in user of the user A.

### <Description of Processing of Delivery Task Management Server>

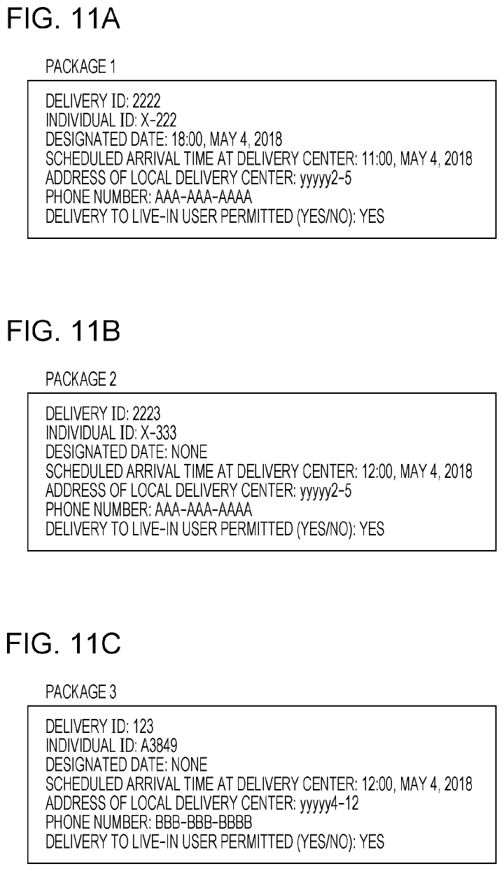

Next, the processing of the delivery task management server 200 will be described by giving a specific example. First, the delivery request information obtaining unit 211 accesses the delivery company server 500 of each delivery company regularly (for instance, every hour), and obtains information on a package delivery request made by a user to the delivery company. The delivery request information obtaining unit 211 obtains information on a delivery request for a package addressed to a user who has permitted disclosure of the information on the user to the delivery system 1. FIGS. 11A to 11C each illustrate an example of information on a package delivery request made by a user to a delivery company.

FIGS. 11A and 11B illustrate information on a package delivery request made by a user to the delivery company B. FIG. 11C illustrates information on a delivery request made by a user to the delivery company C. A delivery ID assigned to each delivery request is an ID granted by a delivery company in its own way.

It is to be noted that a receiver who receives a package may be designated although such a receiver is designated in the example illustrated in FIGS. 11A to 11C. When a receiver is designated, a package is handed over the designated receiver. When the designated receiver is not at home, a package is delivered again. For collectively delivered multiple packages, when a receiver is designated for each of the packages, each package is handed over a corresponding receiver for the package.

The delivery task generator 213 generates a delivery task for each delivery of a package based on the information on package delivery in FIGS. 11A to 11C obtained by the delivery request information obtaining unit 211, and the information of a user obtained by the user information obtaining unit 212.

More specifically, for package 1 (delivery ID: 2222) illustrated in FIG. 11A, the individual ID of the user at a delivery destination is “X-222”, and it is confirmed by searching the user information table that the individual ID indicates the user A with a common ID “C-8797” (see FIG. 9A). Similarly, for package 2 (delivery ID: 2223) illustrated in FIG. 11B, the individual ID of the user at a delivery destination is “X-333”, and it is confirmed by searching the user information table that the individual ID indicates the user C with a common ID “C-9987” (see FIG. 10C). In addition, for package 3 (delivery ID: 123) illustrated in FIG. 11C, the individual ID of the user at a delivery destination is “A3849”, and it is confirmed by searching the user information table that the individual ID indicates the user A with a common ID “C-8797” (see FIG. 9A).

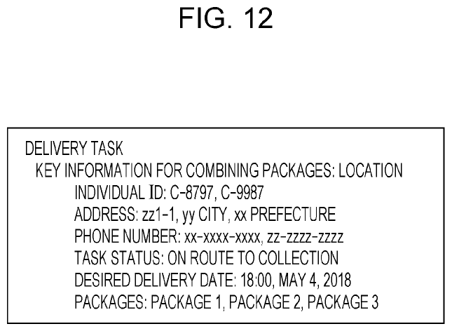

Thus, the delivery destination of the package 1, the delivery destination of the package 3 are the address of the user A, and the delivery destination of the package 2 is the address of the user C who is a live-in user of the user A. Thus all delivery destinations are the same location. Therefore, the delivery task generator 213 generates one delivery task by combining these three packages using the location of a delivery destination of each package as the key. FIG. 12 illustrates an example of a delivery task generated by the delivery task generator 213. As illustrated, in a delivery task, information on the key used for combining delivery tasks (location in the illustrated example), and information on the common ID of the user at a delivery destination, the address of a delivery destination, the telephone number of a delivery destination, a task status, and a desired delivery date are registered.

As more specifically described below, in this example, for the package 1 to package 3, the period for combining packages is set to “one day” (see FIG. 11). The scheduled arrival times at the delivery center for the three packages fall within one day, thus three delivery tasks are combined to one delivery task.

In this example, for each of three packages, the setting of “live-in user delivery permitted YES/NO” is made and “YES” is set for the three packages. Therefore, the three packages are combined to one delivery task. For instance, when the setting for the package 1 is “NO”, the package 1 and the package 2 may not be combined. In this case, for instance, one delivery task is generated for the package 1 only, and the package 2 and the package 3 are combined to one delivery task. Alternatively, the package 1 and the package 3 addressed to the same user A may be combined to one delivery task, and one delivery task may be generated for the package 2 only.

When the setting of “live-in user delivery permitted YES/NO” is made for each package, the setting of “live-in user delivery permitted YES/NO” for each user registered in the user information table is referred to. In other words, in the setting of “live-in user delivery permitted YES/NO”, setting for each package has a higher priority than setting for each user.

In this example, the desired delivery date for delivery task is set to “18:00 on May 4, 2018” for the package 1. However, when multiple packages are combined to one delivery task, and desired delivery dates for the multiple packages are designated, the earliest desired delivery date is set as the desired delivery date for the one delivery task.

### <Description of Processing of Delivery Schedule Management Server>

Next, the processing of the delivery schedule management server 300 will be described by giving a specific example. The delivery task obtaining unit 311 obtains information on a delivery task generated by the delivery task management server. For each delivery task obtained by the delivery task obtaining unit 311, the schedule generator 312 generates a delivery schedule for delivery made by a delivery person. In this example, the schedule generator 312 is assumed to generate a delivery schedule for the delivery task illustrated in FIG. 12.

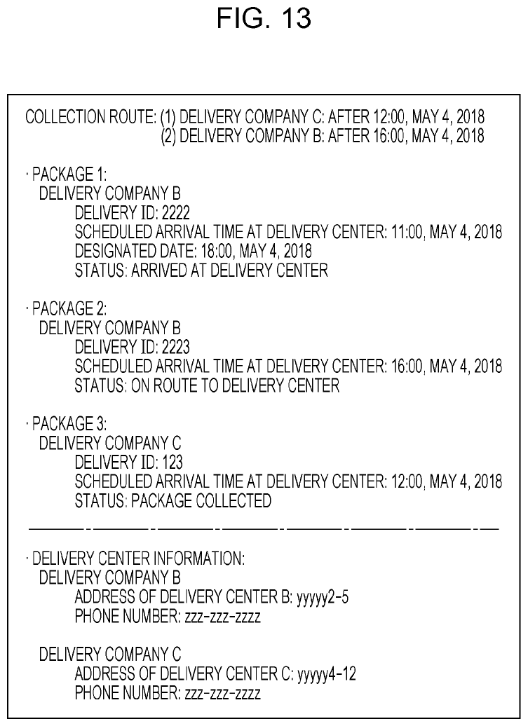

FIG. 13 illustrates an example of a delivery schedule generated by the schedule generator 312. The delivery schedule includes information on each package included in a delivery task, information on a delivery center at which the package arrives, and information on collection route. In the illustrated example, the addresses of delivery centers includes the address of delivery center B of the delivery company B that manages the package 1 and the package 2, and the address of delivery center C of the delivery company C that manages the package 3. The addresses of these delivery centers are obtained from the delivery company servers 500 of the delivery companies. For each of the packages 1 to 3, a scheduled time of arrival at the delivery center is set. The scheduled time of arrival is calculated by each delivery company, and is obtained from the delivery company server 500. A collection route is planned based on the address of a delivery center, and the scheduled time of arrival at the delivery center.

More specifically, the scheduled time of arrival of the package 1 at the delivery center B is 11:00 on May 4, 2018. In addition, the scheduled time of arrival of the package 2 at the delivery center B is 16:00 on May 4, 2018. In addition, the scheduled time of arrival of the package 3 at the delivery center C is 12:00 on May 4, 2018. Here, the package 1 and the package 2 arrive at the same delivery center B, and the scheduled time of arrival of the package 2 is later between the packages 1 and 2. A collection route is determined so that a delivery person arrives at the delivery center B after the arrival of the package 2 (specifically, after 16:00 on May 4, 2018). Since the scheduled time arrival of the package 3 at the delivery center C is 12:00 on May 4, 2018, a collection route is determined so that a delivery person first goes to the delivery center C, and arrives at the delivery center C after the arrival of the package 3 (specifically, after 12:00 on May 4, 2018).

Furthermore, a desired delivery date designated by a user is taken into consideration. In the illustrated example, a desired delivery date for the package 1 designated at 18:00 on May 4, 2018. Thus, it is checked based on the collection route, the address of each delivery center, and the address of a delivery destination whether or not delivery may be made by 18:00 on May 4, 2018. When it is determined that delivery of the package 1 is not made by the desired delivery date, another delivery task for the package 1 is generated.

The schedule notifier 313 notifies the delivery person terminal 400 of a delivery schedule for thus generated delivery task. When multiple delivery persons are involved, the schedule notifier 313 selects a delivery person capable of making delivery in accordance with the delivery schedule based on the delivery schedule and the current locations of delivery persons, and notifies the delivery person terminal 400 of the selected delivery person of the delivery schedule. In addition, when the delivery person is working on or scheduled to work on another delivery task, the schedule notifier 313 determines whether delivery may be made after the completion of the delivery task or by interrupting the delivery task, and notifies the delivery person of the delivery schedule.

The schedule notifier 313 may not select a delivery person, and the administrator or the like of the delivery system 1 may select a delivery person. Alternatively, the delivery person himself/herself may select a delivery task

For each delivery task, the delivery status manager 314 updates the task status of the delivery task, and updates the package status of a package.

The task status of the delivery task includes “new”, “on route to collection”, “on route to delivery”, “completed”, and “on standby”. “New” is a status in which a delivery task is generated, and a delivery person has not been assigned yet. “On route to collection” is a status in which a delivery person is on route to collect a package. “On route to delivery” is a status in which a delivery person completes collection of a package, and is on route to a delivery destination. “Completed” is a status in which delivery of a package is completed. “On standby” is a status in which delivery of a package is completed, and a certain time has elapsed.

The package status of a package includes “on route to delivery center”, “arrived at delivery center”, “package collected”, and “completed”. “On route to delivery center” is a status in which a package has not arrived at a delivery center yet. “Arrived at delivery center” is a status in which a package has arrived at a delivery center, but the package has not been collected. “Package collected” is a status in which a package has been collected by a delivery person. “Completed” is a status in which delivery of a package is completed.

The delivery status notifier 315 notifies the user A and the user C as the delivery destinations of the packages 1 to 3 of the information on the package status and the current position of the packages, and the scheduled time of arrival of the packages. In addition, the delivery status notifier 315 instructs the delivery company server 500B not to deliver the package 1 and the package 2. The delivery status notifier 315 instructs the delivery company server 500C not to deliver the package 3. When delivery of the packages 1 to 3 is completed, the delivery status notifier 315 notifies the delivery company server 500B that delivery of the packages 1 and 2 is completed. Also, the delivery status notifier 315 notifies the delivery company server 500C that delivery of the package 3 is completed.

Although a delivery person goes to a delivery center, a package may not have arrived at a delivery center by a scheduled arrival time. In this case, when the delivery person is scheduled to go to other delivery center in the delivery schedule, the schedule is changed so that the delivery person goes to the other delivery center. At this point, the delivery person notifies the delivery schedule management server 300 that the schedule is changed and the delivery person goes to the other delivery center. Even when a delivery person returns to a delivery center again, if the package has not arrived to the delivery center yet, delivery of the package is cancelled. At this point, the delivery person notifies the delivery schedule management server 300 that delivery of the package is cancelled. The delivery schedule management server 300 notifies the delivery company server 500 which manages the package for which delivery is cancelled and the client terminal 600 of a user who has requested delivery of the package that delivery of the package is cancelled. When delivery of a package is cancelled, a user who has requested the delivery may talk to a delivery company to determine whether the package is delivered later or the delivery of the package is cancelled, for instance.

When receiving a package at a delivery center, the delivery person presents authentication information (for instance, a password) sent in advance from the delivery company server 500 to show that the delivery person is authorized to receive the package. When authentication is confirmed, the package is passed from the delivery center to the delivery person.

All the delivery tasks generated by the delivery task management server 200 may not be delivered by the delivery person for the delivery system 1, and part of the delivery tasks may be delivered by a delivery company. In this case, the schedule generator 312 does not generate a schedule for the delivery task of a package to be delivered by a delivery company, and deletes the delivery task from the delivery task storage 214. For each delivery task, the schedule generator 312 notifies the delivery company server 500 of a result of determination as to whether the delivery task is performed by a delivery company or the delivery system 1.

For instance, when there is only one package in a delivery task, the schedule generator 312 inquire the delivery company server 500 which manages the package as to whether the delivery task is performed by the delivery company or the delivery system 1. When no reply is made from the delivery company within a certain time (for instance, within one hour) after the inquiry, the schedule generator 312 notifies the delivery company server 500 that the delivery is left to the delivery company.

For instance, when a desired delivery date for the package is designated and urgent delivery is needed, the schedule generator 312 notifies the delivery company server 500 that the delivery is left to the delivery company. More specifically, for instance, when a user requests that the delivery be completed within a certain time (for instance, within one hour) from the time at which the delivery is checked at the delivery task management server 200 (in other words, the time at which information on a delivery request is obtained by the delivery request information obtaining unit 211), the schedule generator 312 notifies the delivery company server 500 that the delivery is left to the delivery company.

Furthermore, for instance, when the delivery center which manages the package is located outside the area managed by the delivery system 1, the schedule generator 312 notifies the delivery company server 500 that the delivery is left to the delivery company.

In the exemplary embodiment, the delivery request information obtaining unit 211 of the delivery task management server 200 does not necessarily obtain information on a delivery request from the delivery company server 500. For instance, when a user purchases a product via a website on the Internet using the client terminal 600, the delivery request information obtaining unit 211 may directly obtain information on a delivery request from a system including the website via which the product is purchased. In this case, the delivery request information obtaining unit 211 accesses, for instance, the system of the website regularly (for instance, every hour) to detect a delivery request of the user for a package and shipping of the product from the shop, and obtains information on the delivery request. The delivery task generator 213 then generates a delivery task based on the obtained information on the delivery request. When a delivery company which manages a package is not determined at the time of obtaining the information on a delivery request from the system of the website, the delivery company managing the package is identified by accessing the delivery company server 500 later, for instance.

In addition, when a user purchases multiple products on the Internet using the client terminal 600, instructions for collectively delivering the multiple products may be issued. More specifically, for instance, a user purchases a product at each of multiple shops on the Internet via the client terminal 600. The user then issues instructions for collectively delivering the multiple products purchased via the client terminal 600. When receiving the instructions for collectively delivering the multiple products, the client terminal 600 transmits information on the received instructions to the common user management server 100, the delivery task management server 200, and the delivery schedule management server 300. The delivery task generator 213 of the delivery task management server 200 then generates a delivery task based on the information transmitted. A user may designate a period for collectively delivering multiple products, for instance, an upper limit period during which each individual product is allowed to stay in the delivery center.

In this manner, information on a delivery request is obtained earlier by directly obtaining the information on a delivery request from the system of the website as compared with when the information on a delivery request is obtained from the delivery-company server 500, for instance. Therefore, for instance, a delivery task is generated earlier, and a delivery person is ensured.

In the exemplary embodiment, the registration user information receiving unit 111 of the common user management server 100 receives user information from the client terminal 600 as the processing of the user registration of delivery system 1.

However, without being limited to this configuration, user registration of the delivery system 1 may be received via the delivery company server 500, for instance. In this case, selection for utilization of the delivery system 1 is received on the user registration screen of the delivery company server 500, for instance. For a user who has selected to utilize the delivery system 1, it is confirmed whether the user permits disclosure of the information on the user to the delivery system 1. The user information obtaining unit 212 of the delivery task management server 200 accesses each delivery company server 500 regularly (for instance, every hour), and determines whether or not any user has not been registered in the user information table yet among the users who have permitted disclosure of the information on the users to the delivery system 1. When a user has not been registered yet, information on the user is obtained from the delivery company server 500. User registration is performed based on the information obtained. The address of a newly registered user is compared with the addresses of registered users, and it is determined whether or not the newly registered user is a live-in user. When the newly registered user is a live-in user, information on the live-in user is registered to each relevant user.

A delivery company may be newly added to be utilized by a user registered already via the user registration screen of the delivery company server 500. Thus, for a user who has added a delivery company to be utilized among the users who have permitted disclosure of the information on the users to the delivery system 1, even when the user has been registered in the user information table, the user information obtaining unit 212 obtains information such as the individual ID of the user from the delivery company server 500. The information obtained is added to the user information table.

In the exemplary embodiment, a delivery person does not necessarily delivers a package. For instance, a self-propelled delivery system may deliver a package. In this case, when notified of a delivery schedule from the schedule notifier 313, a self-propelled delivery system picks up a package at a delivery center in accordance with the delivery schedule notified, and delivers the picked up package to a delivery destination. Similarly to the delivery person terminal 400, the self-propelled delivery system exchanges information with the common user management server 100, the delivery task management server 200, the delivery schedule management server 300, the delivery company server 500, and the client terminal 600 via the network 700.

In the exemplary embodiment, three server devices, specifically, the common user management server 100, the delivery task management server 200, and the delivery schedule management server 300 are provided as separate devices. However, these functions may be implemented by one server device or two server devices. As an additional remark, among the function of the common user management server 100, the function of the delivery task management server 200, and the function of the delivery schedule management server 300, a program which implements all the functions or a program which implements part of the functions may be used.

In the exemplary embodiment, similarly to the function of the common user management server 100, the function of the delivery task management server 200, and the function of the delivery schedule management server 300, the function of the delivery person terminal 400 and the function of the client terminal 600 are implemented, for instance, by reading various programs stored in a HDD into a RAM, and executing the programs by a CPU.

Needless to say, each program that implements the exemplary embodiment of the present disclosure may be provided by a communication unit, or the program may be stored in a recording medium such as a CD-ROM, and provided.

Although various exemplary embodiment and modifications have been described above, those exemplary embodiment and modifications may be combined.

The present disclosure is not limited to the above-described exemplary embodiment, and may be practiced in various forms without departing from the spirit of the present disclosure.

The foregoing description of the exemplary embodiment of the present disclosure has been provided for the purposes of illustration and description. It is not intended to be exhaustive or to limit the disclosure to the precise forms disclosed. Obviously, many modifications and variations will be apparent to practitioners skilled in the art. The embodiment was chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. A delivery system comprising:
a receiving unit that receives permission from a receiver who receives a plurality of packages, the permission allowing a plurality of delivery companies to inquire for information on the receiver;
an obtaining unit that, when the permission is granted, from each of the plurality of delivery companies, obtains information on a corresponding one of the plurality of packages addressed to the receiver; and
a generation unit that, when the information obtained by the obtaining unit satisfies a predetermined condition, generates information which allows the plurality of packages addressed to the receiver to be collectively delivered.

2. The delivery system according to claim 1,
wherein the predetermined condition is that when an address of a delivery destination of each of the plurality of packages is designated, the address is common between the plurality of packages, and when the address of the delivery destination of each of the plurality of packages is not designated, the receiver is common between the plurality of packages.

3. The delivery system according to claim 1,
wherein the generation unit further generates information which allows a package addressed to the receiver and a package addressed to one or more other receivers having a same address as the receiver to be collectively delivered.

4. The delivery system according to claim 3,
wherein when the package addressed to the receiver and the package addressed to the one or more other receivers are not permitted to be collectively delivered, the generation unit generates information which allows the package addressed to the receiver and the package addressed to the one or more other receivers to be separately delivered.

5. The delivery system according to claim 1,
wherein the receiving unit receives, from the receiver, settings for allowing or disallowing a package addressed to the receiver and a package addressed to one or more other receivers having a same address as the receiver to be collectively delivered.

6. The delivery system according to claim 5,
wherein the receiving unit further receives settings for allowing or disallowing the package addressed to the receiver and the package addressed to the one or more other receivers to be collectively delivered, according to a type of the package addressed to the receiver.

7. The delivery system according to claim 1,
wherein the receiving unit receives, from the receiver, settings for allowing or disallowing a package addressed to the receiver and a package addressed to another receiver having a same address as the receiver to be separately delivered.

8. The delivery system according to claim 1, further comprising
an instruction unit that, when a package included in information obtained from a delivery company by the obtaining unit is delivered by a delivery unit of the delivery system not of the delivery company, instructs the delivery company not to deliver the package.

9. The delivery system according to claim 1, further comprising
a notification unit that, when a package included in information obtained from a delivery company by the obtaining unit is delivered by a delivery unit of the delivery system not of the delivery company, in response to completion of delivery of the package by the delivery unit, notifies the delivery company of the completion of delivery of the package.

10. A non-transitory computer readable medium storing a program causing a computer to execute a process, the process comprising:
receiving permission from a receiver who receives a plurality of packages, the permission allowing a plurality of delivery companies to inquire for information on the receiver;
when the permission is granted, from each of the plurality of delivery companies, obtaining information on a corresponding one of the plurality of packages addressed to the receiver; and
when the information obtained in the obtaining satisfies a predetermined condition, generating information which allows the plurality of packages addressed to the receiver to be collectively delivered.

11. A non-transitory computer readable medium storing a program causing a computer to execute a process, the process comprising:
receiving from a user instructions to collectively deliver a plurality of products purchased by the user at a plurality of shops on Internet; and
transmitting the instructions to a delivery system which takes over from a delivery company delivery of a product collected for delivery by the delivery company, and delivering the product to a delivery destination.

12. The non-transitory computer readable medium storing a program according to claim 11,
wherein the instructions include designation of an upper limit period during which the product is allowed to stay in the delivery company to collectively deliver the plurality of products.
